(19) United States
(12) Patent Application Publication
(10) Pub. No.: US 2025/0372008 A1
(43) Pub. Date: Dec. 4, 2025

(54) ADAPTIVE HEAD UP DISPLAY

(71) Applicant: Ford Global Technologies, LLC, Dearborn, MI (US)

(72) Inventors: Mahmoud Yousef Ghannam, Canton, MI (US); Nicholas Colella, Grosse Ile, MI (US); Walter Joseph Talamonti, Canton, MI (US); Benjamin Lewis, Livonia, MI (US)

(73) Assignee: Ford Global Technologies, LLC, Dearborn, MI (US)

(21) Appl. No.: 18/732,684

(22) Filed: Jun. 4, 2024

(51) Int. Cl. G09G 3/00; B60K 35/235; B60N 2/02; B60N 2/16

(52) U.S. Cl. CPC G09G 3/002; B60K 35/235; B60N 2/0273; B60N 2/0278; B60N 2/16; B60K 2360/741; G09G 2340/0464; G09G 2380/10

(57) ABSTRACT

A virtual image plane is determined with respect to a reference eyebox. A virtual image projected into the virtual image plane is visible in the reference eyebox. An occupant eyebox is determined from sensor data. A first adjustment is performed of the virtual image plane based on the occupant eyebox so that the virtual image projected into the virtual image plane is visible in the occupant eyebox.

### BACKGROUND

An augmented-reality head up display (AR HUD) for a vehicle can include a projector that projects graphical images for display on a semi-transparent windshield that serves as a combiner or can include an array of holographic optical elements attached to the windshield. Accordingly, the projected graphical images can appear at a virtual image plane that is located in a forward direction with respect to the vehicle. Graphical images appearing in a virtual image plane forward of the vehicle can thus appear to be in a plane that coincides with a real object viewable through the semi-transparent windshield.

### BRIEF DESCRIPTION OF THE DRAWINGS

FIG. 1 is a block diagram illustrating an example vehicle control system.

FIG. 2 is a diagram illustrating an example virtual image plane determined with respect to a reference eyebox.

FIG. 3 is a diagram illustrating a comparison of the virtual image plane to an example occupant virtual image plane determined with respect to an occupant eyebox.

FIG. 4A is a diagram illustrating a comparison between the virtual image plane at a predetermined distance and the virtual image plane at an expected distance from the occupant eyebox.

FIG. 4B is a diagram illustrating an exemplary adjustment of a seat occupied by the occupant to account for a difference between the predetermined distance and the expected distance.

FIG. 5 is an example neural network.

FIG. 6 is an example flowchart of an example process for adapting a virtual image plane based on an occupant eyebox.

### DETAILED DESCRIPTION

A system includes a computer including a processor and a memory, the memory storing instructions executable by the processor to determine a virtual image plane with respect to a reference eyebox. A virtual image projected into the virtual image plane is visible in the reference eyebox. The instructions further include instructions to determine, from sensor data, an occupant eyebox. The instructions further include instructions to perform a first adjustment of the virtual image plane based on the occupant eyebox so that the virtual image projected into the virtual image plane is visible in the occupant eyebox.

The first adjustment may include translating the virtual image plane along at least one of a lateral axis partially defining the virtual image plane, and a vertical axis partially defining the virtual image plane and extending normal to the lateral axis.

The first adjustment may include translating the virtual image within the virtual image plane.

The instructions can further include instructions to perform an adjustment to a position of a seat occupied by an occupant so that the virtual image is visible in the occupant eyebox.

The instructions can further include instructions to perform a second adjustment of the virtual image plane based on occupant data for an occupant. The second adjustment may include translating the virtual image plane along a longitudinal axis extending normal to the virtual image plane. The instructions can further include instructions to input the occupant data for the occupant into a machine learning program that outputs an expected distance from the occupant eyebox to the virtual image plane. The second adjustment may include translating the virtual image plane along a longitudinal axis extending normal to the virtual image plane so that the virtual image plane is spaced from the occupant eyebox along the longitudinal axis by the expected distance. The instructions can further include instructions to perform the second adjustment based on weather data in addition to the occupant data. The instructions can further include instructions to perform an adjustment to a position of a seat occupied by the occupant so that the virtual image projected into the virtual image plane is visible in the occupant eyebox.

A method includes determining a virtual image plane with respect to a reference eyebox. A virtual image projected into the virtual image plane is visible in the reference eyebox. The method further includes determining, from sensor data, an occupant eyebox. The method further includes performing a first adjustment of the virtual image plane based on the occupant eyebox so that the virtual image projected into the virtual image plane is visible in the occupant eyebox.

The first adjustment may include translating the virtual image plane along at least one of a lateral axis partially defining the virtual image plane, and a vertical axis partially defining the virtual image plane and extending normal to the lateral axis.

The first adjustment may include translating the virtual image within the virtual image plane.

The method can further include performing an adjustment to a position of a seat occupied by an occupant so that the virtual image is visible in the occupant eyebox.

The method can further include performing a second adjustment of the virtual image plane based on occupant data for an occupant. The second adjustment may include translating the virtual image plane along a longitudinal axis extending normal to the virtual image plane. The method can further include inputting the occupant data for the occupant into a machine learning program that outputs an expected distance from the occupant eyebox to the virtual image plane. The second adjustment may include translating the virtual image plane along a longitudinal axis extending normal to the virtual image plane so that the virtual image plane is spaced from the occupant eyebox along the longitudinal axis by the expected distance. The method can further include performing the second adjustment based on weather data in addition to the occupant data. The method can further include performing an adjustment to a position of a seat occupied by the occupant so that the virtual image projected into the virtual image plane is visible in the occupant eyebox.

Further disclosed herein is a computing device programmed to execute any of the above method steps. Yet further disclosed herein is a computer program product, including a computer readable medium storing instructions executable by a computer processor, to execute an of the above method steps.

A vehicle can include a heads-up display (HUD) that can display content such as information about the vehicle and/or objects around the vehicle to an occupant of the vehicle. The HUD can project images onto a windshield of the vehicle. The HUD can provide content as an augmented reality (AR) image. The HUD can provide the AR image such that, when viewed by the occupant, the AR image is overlayed with the objects around the vehicle. Thus, the HUD can display images in a manner to allow the occupant to view the images while also viewing a roadway along which the vehicle is traveling. However, projecting the images into a single virtual image plane (e.g., on the windshield) for each occupant in a vehicle may result in misalignment and low quality between the image projected in the single virtual image plane and an occupant eyebox (e.g., based on various heights, seat positions, vision acuity, weather conditions, etc.) for various occupants viewing the virtual image plane. Such misalignment and low quality may result in an unsuitable appearance and unclarity of the AR image for the occupant.

As described herein, a vehicle computer can adjust the virtual image plane so that a virtual image projected into the virtual image plane is visible in an occupant eyebox. By adjusting the virtual image plane based on the occupant eyebox, the vehicle computer can enhance the alignment and quality of the AR images with respect to the occupant eyebox, which can thereby provide a suitable appearance with high quality of the AR image to the occupant.

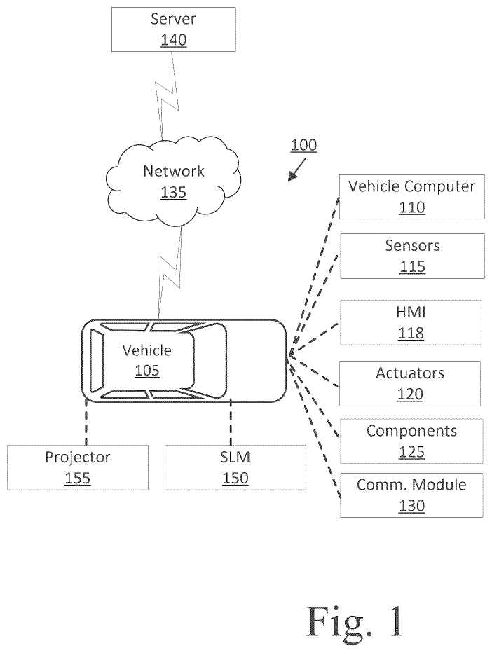

With reference to FIGS. 1-5, an example vehicle control system 100 includes a vehicle 105. A vehicle computer 110 in the vehicle 105 receives data from sensors 115. The vehicle computer 110 is programmed to determine a virtual image plane 200 with respect to a reference eyebox 205. A virtual image projected into the virtual image plane 200 is visible in the reference eyebox 205. The vehicle computer 110 is further programmed to determine, from sensor data, an occupant eyebox 305. The vehicle computer 110 is further programmed to perform a first adjustment of the virtual image plane 200 based on the occupant eyebox 305 so that the virtual image projected into the virtual image plane 200 is visible in the occupant eyebox 305.

Turning now to FIG. 1, the vehicle 105 includes the vehicle computer 110, sensors 115, actuators 120 to actuate various vehicle components 125, and a vehicle communications module 130. The communications module 130 allows the vehicle computer 110 to communicate with a remote server computer 140, and/or other vehicles (e.g., via a messaging or broadcast protocol such as Dedicated Short Range Communications (DSRC), cellular, and/or other protocol that can support vehicle-to-vehicle, vehicle-to infrastructure, vehicle-to-cloud communications, or the like, and/or via a packet network 135).

The vehicle computer 110 includes a processor and a memory such as are known. The memory includes one or more forms of computer-readable media, and stores instructions executable by the vehicle computer 110 for performing various operations, including as disclosed herein. The vehicle computer 110 can further include two or more computing devices operating in concert to carry out vehicle 105 operations including as described herein. Further, the vehicle computer 110 can be a generic computer with a processor and memory as described above, and/or may include an electronic control unit (ECU) or electronic controller or the like for a specific function or set of functions, and/or may include a dedicated electronic circuit including an ASIC that is manufactured for a particular operation (e.g., an ASIC for processing sensor data and/or communicating the sensor data). In another example, the vehicle computer 110 may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming (e.g. stored in a memory electrically connected to the FPGA circuit). In some examples, a combination of processor(s), ASIC(s), and/or FPGA circuits may be included in the vehicle computer 110.

The vehicle computer 110 may include programming to operate one or more of vehicle 105 propulsion, steering, transmission, climate control, interior and/or exterior lights, horn, doors, etc., as well as to determine whether and when the vehicle computer 110, as opposed to a human operator, is to control such operations.

The vehicle computer 110 may include or be communicatively coupled to (e.g., via a vehicle communications network such as a communications bus as described further below) more than one processor (e.g., included in electronic controller units (ECUs) or the like included in the vehicle 105) for monitoring and/or controlling various vehicle components 125 (e.g., a transmission controller, a steering controller, etc.). The vehicle computer 110 is generally arranged for communications on a vehicle communication network that can include a bus in the vehicle 105 such as a controller area network (CAN) or the like, and/or other wired and/or wireless mechanisms.

Via the vehicle 105 network, the vehicle computer 110 may transmit messages to various devices in the vehicle 105 and/or receive messages (e.g., CAN messages) from the various devices (e.g., sensors 115, an actuator 120, ECUs, etc.). Alternatively, or additionally, in cases where the vehicle computer 110 actually comprises a plurality of devices, the vehicle communication network may be used for communications between devices represented as the vehicle computer 110 in this disclosure. Further, as mentioned below, various controllers and/or sensors 115 may provide data to the vehicle computer 110 via the vehicle communication network.

Vehicle 105 sensors 115 may include a variety of devices such as are known to provide data to the vehicle computer 110. For example, the sensors 115 may include Light Detection And Ranging (LIDAR) sensor(s) 115, etc., disposed on a top of the vehicle 105, behind a vehicle 105 front windshield, around the vehicle 105, etc., that provide relative locations, sizes, and shapes of objects surrounding the vehicle 105. As another example, one or more radar sensors 115 fixed to vehicle 105 bumpers may provide data to provide locations of the objects, second vehicles, etc., relative to the location of the vehicle 105. The sensors 115 may further alternatively or additionally, for example, include camera sensor(s) 115 (e.g. front view, side view, etc.) providing images from an area surrounding the vehicle 105. In the context of this disclosure, an object is a physical (i.e., material) item that has mass and that can be represented by physical phenomena (e.g., light or other electromagnetic waves, or sound, etc.) detectable by sensors 115. Thus, the vehicle 105, as well as other items including as discussed below, fall within the definition of “object” herein.

The vehicle computer 110 is programmed to receive data from one or more sensors 115 substantially continuously, periodically, and/or when instructed by a remote server computer 140, etc. The data may, for example, include a location of the vehicle 105. Location data specifies a point or points on a ground surface and may be in a known form (e.g., geo-coordinates such as latitude and longitude coordinates obtained via a navigation system, as is known, that uses the Global Positioning System (GPS)). Additionally, or alternatively, the data can include a location of an object (e.g., a vehicle, a sign, a tree, etc.) relative to the vehicle 105. As one example, the data may be image data of the environment around the vehicle 105. In such an example, the image data may include one or more objects and/or markings (e.g., lane markings) on or along a road. Image data herein means digital image data (e.g., comprising pixels with intensity and color values) that can be acquired by camera sensors 115. The sensors 115 can be mounted to any suitable location in or on the vehicle 105 (e.g., on a vehicle 105 bumper, on a top of a vehicle 105, etc.) to collect images of the environment around the vehicle 105.

The vehicle 105 actuators 120 are implemented via circuits, chips, or other electronic and or mechanical components that can actuate various vehicle subsystems in accordance with appropriate control signals as is known. The actuators 120 may be used to control components 125, including propulsion and steering of a vehicle 105.

In the context of the present disclosure, a vehicle component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a suspension component (e.g., that may include one or more of a damper, e.g., a shock or a strut, a bushing, a spring, a control arm, a ball joint, a linkage, etc.), a park assist component, an adaptive cruise control component, an adaptive steering component, etc.

The vehicle 105 further includes a human-machine interface (HMI) 118. The HMI 118 includes user input devices such as knobs, buttons, switches, pedals, levers, touchscreens, and/or microphones, etc. The input devices may include sensors 115 to detect a user input and provide user input data to the vehicle computer 110. That is, the vehicle computer 110 may be programmed to receive user input from the HMI 118. The occupant may provide the user input via the HMI 118 (e.g., by selecting a virtual button on a touchscreen display, by providing voice commands, etc.). For example, a touchscreen display included in an HMI 118 may include sensors 115 to detect that an occupant selected a virtual button on the touchscreen display to, for example, select or deselect an operation, which input can be received in the vehicle computer 110 and used to determine the selection of the user input.

The HMI 118 typically further includes output devices such as displays (including touchscreen displays), speakers, and/or lights, etc., that output signals or data to the occupant. The HMI 118 is coupled to the vehicle communication network and can send and/or receive messages to/from the vehicle computer 110 and other vehicle sub-systems.

The vehicle 105 further includes an SLM 150. An “SLM” is an object that imposes spatially varying modulation on a beam of light. The SLM 150 is arranged to receive light from a projector 155 and to modulate the light according to a pixel-wise phase matrix (as discussed below) to output the light onto a windshield 210 to provide an augmented reality image that can appear to be exterior to the vehicle 105. The SLM 150 is coupled to the vehicle communication network and can send and/or receive messages to/from the vehicle computer 110 and other vehicle sub-systems.

The vehicle 105 further includes the projector 155. The projector 155 can be arranged to display images in a field of view of an occupant of the vehicle 105. The projector 155 can be arranged to display images vehicle-forward of the occupant to provide information about vehicle surroundings, vehicle operations, etc. For example, the projector 155 can project light onto the windshield 210. Specifically, the projector 155 can project light through the SLM 150 to the windshield 210. The light is reflected by the windshield 210 to provide the augmented reality image in the light of sight of the occupant so as to be viewable by and understood by the occupant. Although the augmented reality image is projected onto the windshield 210, the augmented reality image appear to the occupant to be exterior to the vehicle 105 to provide an augmented reality display of surroundings of the vehicle 105. Specifically, the augmented reality image appears to be in a virtual image plane 200 forward of the vehicle 105, as discussed below. The projector 155 is coupled to the vehicle communication network and can send and/or receive messages to/from the vehicle computer 110 and other vehicle sub-systems.

In addition, the vehicle computer 110 may be configured for communicating via a vehicle-to-vehicle communication module 130 or interface with devices outside of the vehicle 105 (e.g., through a vehicle-to-vehicle (V2V) or vehicle-to-infrastructure (V2X) wireless communications (cellular and/or short-range radio communications, etc.) to another vehicle, and/or to a remote server computer 140 (typically via direct radio frequency communications)). The communications module 130 could include one or more mechanisms, such as a transceiver, by which the computers of vehicles may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the communications module 130 include cellular, Bluetooth, IEEE 802.11, dedicated short range communications (DSRC), cellular V2X (CV2X), and/or wide area networks (WAN), including the Internet, providing data communication services. The label “V2X” is used herein for communications that may be vehicle-to-vehicle (V2V) and/or vehicle-to-infrastructure (V2I), and that may be provided by communication module 130 according to any suitable short-range communications mechanism (e.g., DSRC, cellular, or the like).

The network 135 represents one or more mechanisms by which a vehicle computer 110 may communicate with remote computing devices (e.g., the remote server computer 140, another vehicle computer, etc.). Accordingly, the network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

The remote server computer 140 can be a conventional computing device (i.e., including one or more processors and one or more memories) programmed to provide operations such as disclosed herein. Further, the remote server computer 140 can be accessed via the network 135 (e.g., the Internet, a cellular network, and/or or some other wide area network).

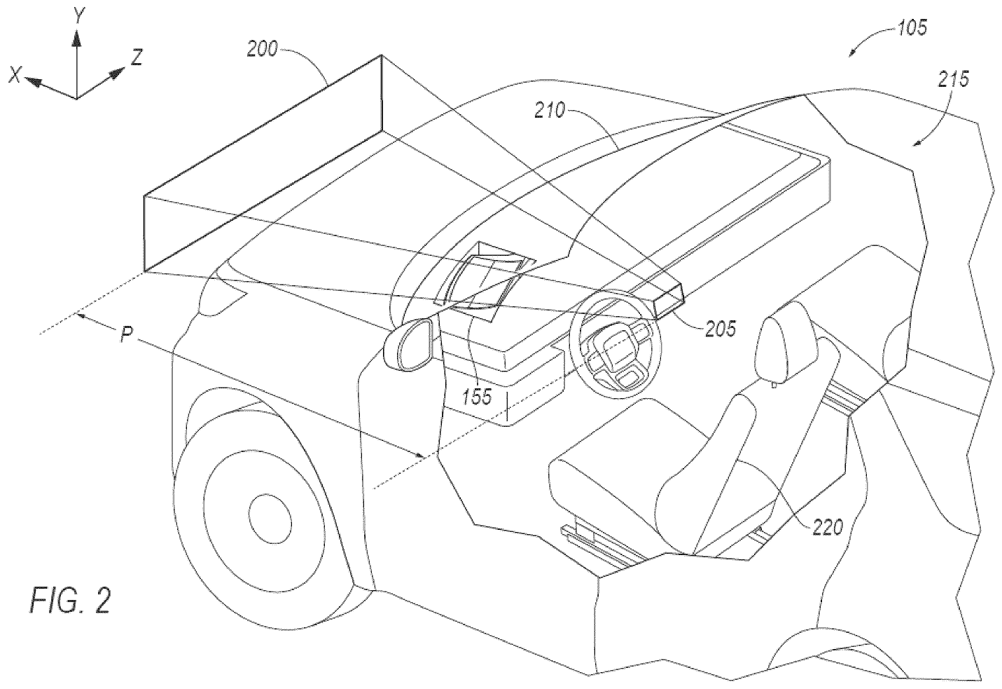

FIG. 2 is a diagram illustrating a virtual image plane 200 for providing a virtual image to a reference eyebox 205. An eyebox is a free space observation plane positioned within a passenger cabin 215 of the vehicle 105. The reference eyebox 205 is described by contextual information including four corners, which are expressed as x, y, and z coordinates with respect to a vehicle coordinate system (e.g., a Cartesian coordinate system having an origin at a predetermined point on and/or in the vehicle 105). The reference eyebox 205 is defined by the y-axis (i.e., extending in a lateral (or cross-vehicle) direction) and z-axis (i.e., extending in a vertical direction). That is, the four corners of the reference eyebox 205 have a same x coordinate value.

The reference eyebox 205 may be a determined empirically (e.g., based on determining via testing and/or simulation an average (or some other statistical measure) height and average (or some other statistical measure) vehicle seat position (e.g., specified according to the vehicle coordinate system) for various occupants). The reference eyebox 205 can be stored (e.g., in a memory of the vehicle computer 110). As another example, the remote server computer 140 can transmit the reference eyebox 205 to the vehicle computer 110 (e.g., via the network 135).

A virtual image plane 200 is a plane that is determined with respect to the reference eyebox 205. That is, the virtual image plane 200 is determined such that a virtual image projected onto the virtual image plane 200 is visible to an observer if the observer's eyes are in the reference eyebox 205. The virtual image plane 200 is described by contextual information including four corners, which are expressed as x, y, and z coordinates with respect to the vehicle coordinate system. The virtual image plane 200 is defined by the y-axis (i.e., extending in a lateral (or cross-vehicle) direction) and z-axis (i.e., extending in a vertical direction). That is, the four corners of the virtual image plane 200 have a same x coordinate value.

The virtual image plane 200 may be determined such that corners of the virtual image plane 200 correspond to the corners of the reference eyebox 205 projected a predetermined distance P along the x-axis (i.e., extending in a longitudinal direction). The coordinates of corners of the reference eyebox 205 can be converted into coordinates of the corners of the virtual image plane 200 based on parameters of one or more vehicle components 125 (e.g., origin point of light from the projector 155) distance from the origin point to the windshield 210, a diffraction angle to direct light to the eyebox of a vehicle occupant, etc. The predetermine distance may be stored (e.g., in a memory of the vehicle computer 110). The predetermined distance P may be determined empirically (e.g., based on determining via testing an average (or some other statistical measure) distance between eyeboxes for various occupants and various virtual image planes that provides desirable appearance virtual images projected into the virtual image plane 200 to the various occupants (e.g., based on user inputs classifying the appearance of various virtual images projected into virtual image planes at various distances from the occupant)). The virtual image plane 200 can be stored (e.g., in a memory of the vehicle computer 110). As another example, the vehicle computer 110 can receive the virtual image plane 200 from the remote server computer 140 (e.g., via the network 135).

A pixel-wise phase matrix is determined based on the virtual image plane 200. A pixel-wise phase matrix is a matrix identifying pixels in the virtual image and specifying a pixel phase for each pixel. A “pixel phase” is an adjustment to a point in time that a sample is taken in an analog-digital conversion. A pixel phase allows for synchronizing pixel (or dot) clocks of the vehicle computer 110 and a projector 155. A “pixel clock” is a speed at which pixels are transmitted such that a full frame of pixels fits within one refresh cycle. Unsynchronized pixel clocks can result in pixel banding (i.e., multiple pixels end at the same pixel coordinates) which reduces the resolution of the virtual image. The projector 155 and the SLM 150 are actuated to output a virtual image into the virtual image plane 200 based on the pixel-wise phase matrix. The pixel-wise phase matrix may be determined empirically (e.g., based on determining via testing and/or simulation a pixel phase for each pixel in a virtual image that allows the virtual image to be projected into the virtual image plane 200). The pixel-wise phase matrix may be stored (e.g., in a memory of the vehicle computer 110). As another example, the vehicle computer 110 can receive the pixel-wise phase matrix from the remote server computer 140 (e.g., via the network 135).

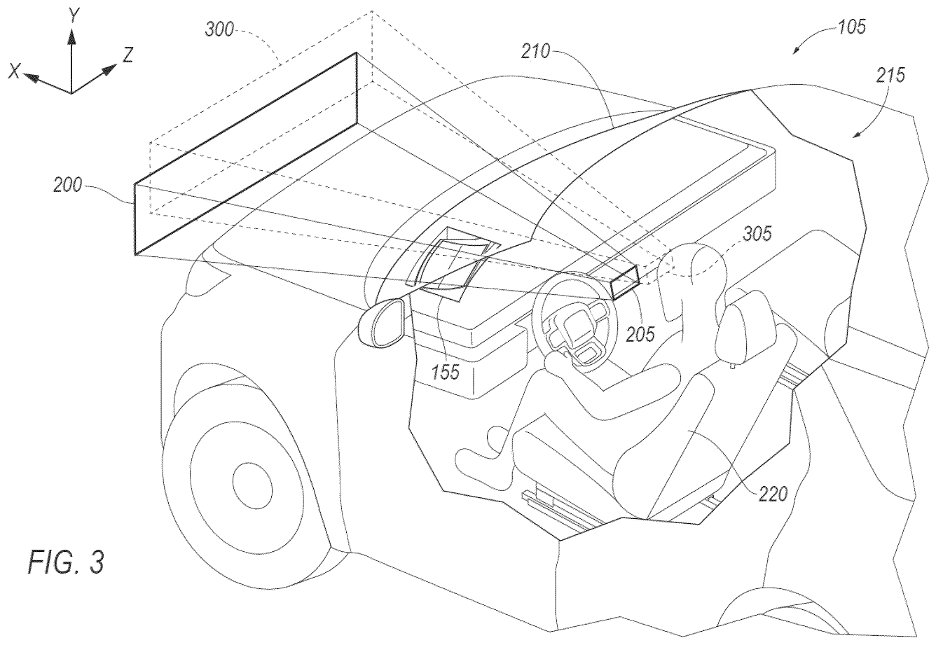

FIG. 3 is a diagram illustrating an offset between the reference eyebox 205 and an occupant eyebox 305 for a vehicle 105 occupant. The vehicle computer 110 can detect an occupant in the passenger cabin 215 based on sensor 115 data. For example, the vehicle computer 110 can receive sensor 115 data from the seat occupancy sensor 115 indicating a presence of an occupant in a seat 220. The seat occupancy sensor 115 may be programmed to detect occupancy of the seat 220. The seat occupancy sensor 115 may, for example, be a post-contact sensor, such as pressure sensors and contact switches. As another example, the seat occupancy sensor 115 may be a sensor (e.g., a voltmeter, ammeter, ohmmeter, etc.) that registers a value of an electrical variable (i.e., a variable whose value specifies some electrical quantity, e.g., voltage, current, resistance, etc.) in an electrical circuit that includes circuit elements in the seat 220. Values of the electrical variable corresponding to an open circuit may be classified as the seat 220 being unoccupied, and values of the electrical variable corresponding to a closed circuit may be classified as the seat 220 being occupied.

Additionally, or alternatively, the vehicle computer 110 can receive sensor 115 data (e.g., image data) from a sensor 115 positioned to face the passenger cabin 215. The sensor 115 data can include one or more objects in the passenger cabin 215. The vehicle computer 110 can identify the occupant from the sensor 115 data. For example, object identification techniques can be used (e.g., in the vehicle computer 110 based on LIDAR sensor 115 data, camera sensor 115 data, etc.) to identify a type of object (e.g., an occupant, a user device, a package, etc.) as well as physical features of objects.

Any suitable techniques may be used to interpret sensor 115 data. For example, camera and/or LIDAR image data can be provided to a classifier that comprises programming to utilize one or more conventional image classification techniques. For example, the classifier can use a machine learning technique in which data known to represent various objects, is provided to a machine learning program for training the classifier. Once trained, the classifier can accept as input vehicle sensor 115 data (e.g., an image) and then provide as output, for each of one or more respective regions of interest in the image, an identification of an occupant or an indication that no occupant is present in the respective region of interest. Further, a coordinate system (e.g., polar or cartesian) applied to an area proximate to the vehicle 105 can be applied to specify locations and/or areas (e.g., according to the vehicle 105 coordinate system, translated to global latitude and longitude geo-coordinates, etc.) of an occupant identified from sensor 115 data. Yet further, the vehicle computer 110 could employ various techniques for fusing (i.e., incorporating into a common coordinate system or frame of reference) data from different sensors 115 and/or types of sensors 115 (e.g., LIDAR, radar, and/or optical camera data).

Upon detecting the occupant in the passenger cabin 215 of the vehicle 105, the vehicle computer 110 can determine an occupant eyebox 305 based on an actual pose for the occupant. The occupant eyebox 305 is described by contextual information including four corners, which are expressed as x, y, and z coordinates with respect to the vehicle coordinate system. The occupant eyebox 305 is a free space observation plane that corresponds to an actual pose of the occupant's eyes.

The vehicle computer 110 can determine the actual pose for the occupant based on sensor 115 data (e.g., image data, seat 220 position data (e.g., specifying a longitudinal and vertical position of a seat bottom relative to an x-axis and a z-axis, respectively, of the vehicle coordinate system and a pitch of a seatback relative to a y-axis of the vehicle coordinate system), radar data, etc.) using any suitable technique. For example, the vehicle computer 110 can obtain an image from an image sensor 115 positioned to face the occupant when the occupant is seated inside the vehicle 105. The vehicle computer 110 can then input the image to a machine learning program that identifies keypoints. The machine learning program can be a conventional neural network trained for processing images (e.g., OpenPose, Google Research and Machine Intelligence (G-RMI), DL-61, etc.). For example, OpenPose receives, as input, an image and identifies keypoints in the image corresponding to human body parts (e.g., hands, feet, joints, head etc.). OpenPose inputs the image to a plurality of convolutional layers that, based on training with a reference dataset such as Alpha-Pose, identify keypoints in the image and output the keypoints. The keypoints include depth data that the image alone does not include, and the vehicle computer 110 can use a machine learning program such as OpenPose to determine the depth data to identify the actual pose of the occupant in the image. That is, the machine learning program outputs the keypoints as a set of three values: a length along a first axis of a 2D coordinate system in the image, a width along a second axis of the 2D coordinate system in the image, and a depth from the image sensor 115 to the vehicle occupant, the depth typically being a distance along a third axis normal to a plane defined by the first and second axes of the image. The vehicle computer 110 can then connect the keypoints (e.g., using data processing techniques) to determine the actual pose of the occupant.

Upon determining the pose of the occupant's head (e.g., vehicle coordinates specifying the keypoint corresponding to the occupant's head) the vehicle computer 110 can (e.g., using known facial feature identification algorithms) determine coordinates for the occupant's eyes relative to a head of the occupant (i.e., in a coordinate system having an origin at the keypoint corresponding to the occupant's head). The vehicle computer 110 can then transform (e.g., according to known coordinate transformation techniques) the coordinates of the occupant's eyes relative to the head of the occupant into the vehicle coordinate system based on the pose of the occupant's head. Upon determining coordinates of the occupant's eyes in the vehicle coordinate system, the vehicle computer 110 determines coordinates of the corners of the occupant eyebox 305 such that the occupant's eyes are positioned (e.g., centered) within the occupant eyebox 305.

The vehicle computer 110 is programmed to determine whether a first adjustment on the virtual image plane 200 is needed based on the occupant eyebox 305. The vehicle computer 110 can, for example, convert the coordinates of the corners of the occupant eyebox 305 based on the vehicle component 125 parameters, as discussed above, to determine coordinates specifying four corners of an occupant virtual image plane 300 (i.e., a virtual image plane that diffracts light into the occupant eyebox 305). The vehicle computer 110 can then compare the coordinates of the corners of the occupant virtual image plane 300 to the corresponding coordinates of the corners of the virtual image plane 200. If the coordinates of the corners of the occupant virtual image plane 300 match the corresponding coordinates of the corners of the virtual image plane 200, then the vehicle computer 110 determines that the first adjustment is not needed. If the coordinates of the corners of the occupant virtual image plane 300 do not match the corresponding coordinates of the corners of the virtual image plane 200, then the vehicle computer 110 determines that the first adjustment is needed.

To perform the first adjustment, the vehicle computer 110 can translate the virtual image plane 200 along at least one of the y-axis and the z-axis of the vehicle coordinate system. That is, the vehicle computer 110 can transform coordinates specifying the virtual image plane 200 from a first set of (e.g., y and z) coordinates to a second set of (e.g., y and z) coordinates. For example, the vehicle computer 110 can translate the virtual image plane 200 along the y-axis and/or the z-axis so that the coordinates of the corners of the virtual image plane 200 match the coordinates of the corners of the occupant virtual image plane 300. In such an example, the vehicle computer 110 may be programmed to cause or allow an actuator 120 of the projector 155 and/or an actuator of the SLM 150 to adjust an angle at which light is projected towards the windshield 210 from the projector 155 and/or the SLM 150 so as to translate the virtual image plane 200.

Additionally, or alternatively, to perform the first adjustment, the vehicle computer 110 can translate the virtual image along at least one of the y-axis and the z-axis of the vehicle coordinate system. For example, the vehicle computer 110 can actuate the projector 155 and/or the SLM 150 to project a reference virtual image based on the pixel-wise phase matrix. In such an example, at least a portion of the reference virtual image may not be visible within the occupant eyebox 305. The vehicle computer 110 can translate the reference virtual image along the y-axis and/or the z-axis so that the reference virtual image is visible within the occupant eyebox 305. In such an example, the vehicle computer 110 can determine an updated pixel-wise phase matrix (e.g., according to known matrix transformation techniques) based on translating the reference virtual image along the lateral axis and/or the vertical axis so that the reference virtual image is visible within the occupant eyebox 305. The updated pixel-wise phase matrix can be stored (e.g., in a memory of the vehicle computer 110).

Additionally, or alternatively, the vehicle computer 110 may be programmed to perform an adjustment of the seat 220 occupied by the occupant. In such an example, the vehicle computer 110 can actuate an actuator 120 of the seat 220 to move the seat 220 along the y-axis (e.g., relative to a seat track) and/or can actuate an actuator 120 of the seat 220 to rotate a seatback about the y-axis (e.g., relative to a seat bottom). Adjusting the seat 220 may reduce or eliminate the need for the vehicle computer 110 to translate of the virtual image plane 200 and/or the virtual image so as to make the virtual image projected into the virtual image plane 200 visible within the occupant eyebox 305. That is, moving the seat bottom along the y-axis and/or rotating the seatback about the y-axis, may at least partially account for coordinates of the corners of the occupant eyebox 305 not matching coordinates for the corners of the reference eyebox 205. As another example, the vehicle computer 110 may be programmed to actuate the HMI 118 to output an alert to the occupant to perform an adjustment to the seat 220 so as to make the virtual image visible within the occupant eyebox 305.

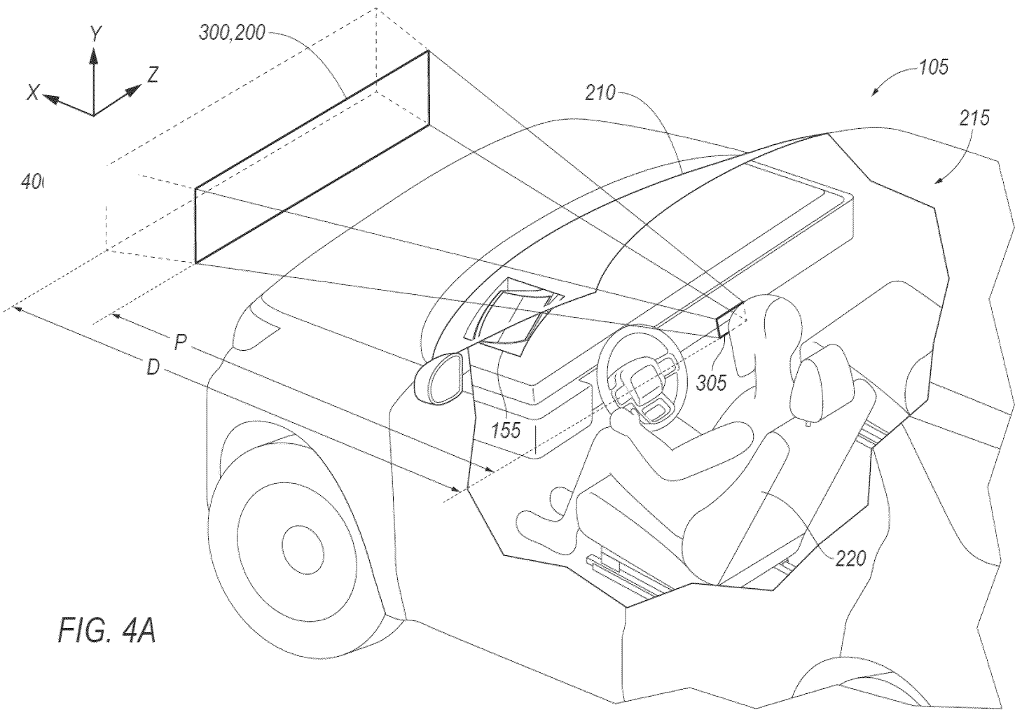

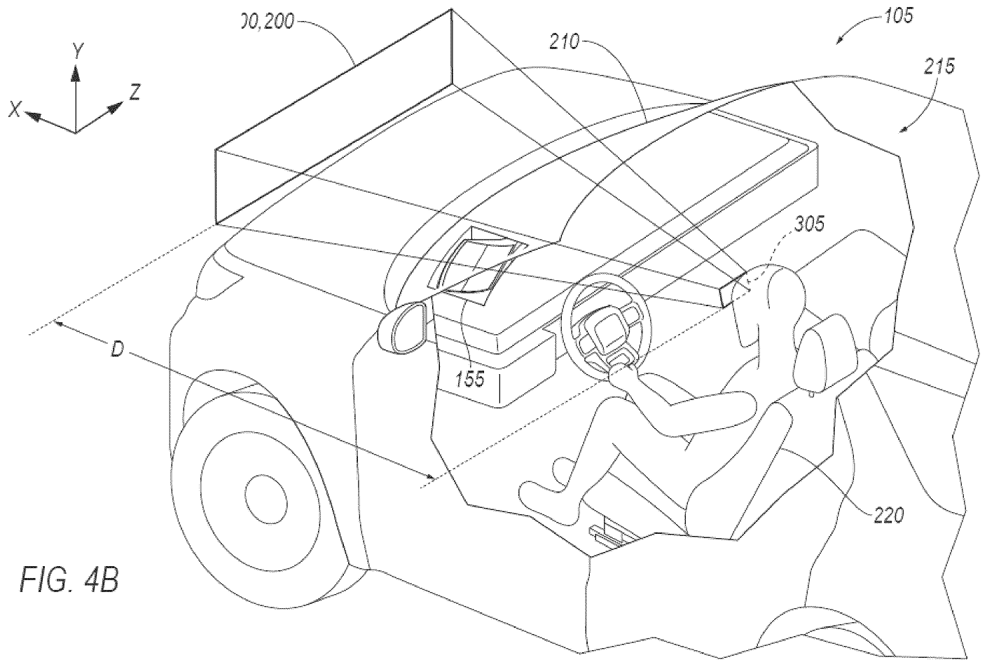

FIG. 4A is a diagram illustrating a difference between the predetermined distance P from the reference eyebox 205 to the virtual image plane 200 and an expected distance D between the occupant eyebox 305 and the virtual image plane 200. The vehicle computer 110 can determine whether a second adjustment on the virtual image plane 200 is needed based on the expected distance D between the occupant eyebox 305 and the virtual image plane 200. Upon determining the expected distance D between the occupant eyebox 305 and the virtual image plane 200 (discussed below), the vehicle computer 110 can compare the expected distance D to the predetermined distance P. If the expected distance D equals the predetermined distance P, then the vehicle computer 110 determines that the second adjustment is not needed. If the expected distance D does not equal the predetermined distance P, then the vehicle computer 110 determines that the second adjustment is needed.

The vehicle computer 110 can determine the expected distance D between the occupant eyebox 305 and the virtual image plane 200 based on occupant data. As used herein, “occupant data” is data specific to an occupant. The occupant data can, for example, identify an occupant's vision acuity (i.e., a measure of a spatial resolution of the occupant's visual processing ability, i.e., a spatial resolution at which the occupant can reasonably view content with respect to the eyebox). The vehicle computer 110 can, for example, determine the occupant data based on a user input. For example, the vehicle computer 110 can actuate and/or instruct the HMI 118 to display virtual buttons corresponding to various vision acuities that the occupant can select to specify the vision acuity of the occupant. In other words, the HMI 118 may activate sensors that can detect the occupant selecting virtual buttons to specify the vision acuity of the occupant. Upon detecting the user input, the HMI 118 can provide the user input to the vehicle computer 110, and the vehicle computer 110 can determine the vision acuity of the occupant based on the user input. Additionally, or alternatively, the vehicle computer 110 can determine the occupant data based on sensor 115 data. For example, the vehicle computer 110 can determine an eyeglass prescription of the occupant based on image data. In such an example, the classifier can be further trained to accept as input image data including eyeglasses of an occupant, and to output a prescription of the eyeglasses.

The occupant data can further identify the expected distance D between the occupant eyebox 305 and the virtual image plane 200. In such an example, the vehicle computer 110 can actuate and/or instruct the HMI 118 to display virtual buttons corresponding to various expected distance Ds at which to position the virtual image plane 200 from the occupant that the occupant can select to specify the expected distance D between the occupant eyebox 305 and the virtual image plane 200. In other words, the HMI 118 may activate sensors that can detect the occupant selecting virtual buttons to specify an expected distance D between the occupant eyebox 305 and the virtual image plane 200. Upon detecting the user input, the HMI 118 can provide the user input to the vehicle computer 110, and the vehicle computer 110 can determine the expected distance D between the occupant eyebox 305 and the virtual image plane 200 based on the user input.

The occupant data can further identify a position of the seat 220 occupied by the occupant. The vehicle computer 110 can, for example, determine a seat 220 position relative to the x-axis and/or the z-axis of the vehicle coordinate system based on a seat position sensor 115 specifying a relative position of a seat bottom along a seat track and/or a relative height of the seat bottom relative to the seat track. As another example, the vehicle computer 110 can determine a seatback rotational position about the y-axis of the vehicle coordinate system based on a seatback sensor specifying an inclination angle of the seatback relative to the seat bottom.

The vehicle computer 110 can store the occupant data for each occupant. For example, the vehicle computer 110 can maintain a look-up table, or the like, that associates various occupant data with various occupants. The vehicle computer 110 can, for example, identify the occupant based on sensor 115 data (e.g., via known facial recognition algorithms). The vehicle computer 110 can then access the look-up table to determine the occupant data associated with an identified occupant.

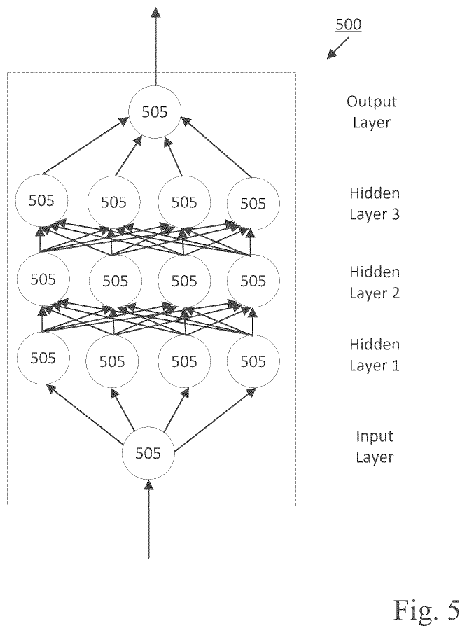

In one example, the vehicle computer 110 can determine the expected distance D between the virtual image plane 200 and the occupant eyebox 305 based on an expected distance D specified by the user input, as discussed above. As another example, the vehicle computer 110 can determine the expected distance D between the occupant eyebox 305 and the virtual image plane 200 by inputting the occupant data and/or weather data into a neural network, such as a deep neural network (DNN) 500 (see FIG. 5). The DNN 500 can be trained (as discussed below) to accept the occupant data and/or weather data as input and generate an output specifying an expected distance D between the occupant eyebox 305 and the virtual image plane 200. Weather data is typically collected by vehicle 105 sensors 115, but alternatively or additionally could be provided from a source outside the vehicle 105 (e.g., a remote server computer 140) based on time or times that the vehicle 105 is at or traveling through a specified location. Determining the expected distance based on occupant data and/or weather data allows for adapting a distance between the occupant eyebox 305 and the virtual image plane 200 to account for various conditions that may influence the appearance of the AR image (e.g., various vision acuities of various occupants, various meteorological visibility measures (i.e., distances at which an object or light can be discerned in given weather conditions), etc.).

To perform the second adjustment, the vehicle computer 110 can translate the virtual image plane 200 along the x-axis of the vehicle coordinate system. For example, the vehicle computer 110 can translate the virtual image plane 200 along the x-axis by adding (or subtracting) a difference between the expected distance D and the predetermined distance P to the x-coordinates of the corners of the virtual image plane 200. That is, the vehicle computer 110 can translate the virtual image plane 200 so that the virtual image plane 200 is spaced from the occupant eyebox 305 by the expected distance D. In such an example, the vehicle computer 110 may be further programmed to update the pixel-wise phase matrix (e.g., according to known matrix transformation techniques) so that the virtual image is projected into the virtual image plane 200 after the second adjustment is performed.

Additionally, or alternatively, the vehicle computer 110 may be programmed to perform the adjustment of the seat 220 occupied by the occupant. In such an example, the vehicle computer 110 can actuate an actuator 120 of the seat 220 to move the seat 220 along the x-axis (e.g., along a seat track) and/or can actuate an actuator 120 of the seat 220 to rotate a seatback about the y-axis (e.g., relative to a seat bottom). For example, as shown in FIG. 4B, the vehicle computer 110 can actuate the seat 220 to move along the seat track so that the expected distance D is equal to the predetermined distance P. Adjusting the seat 220 may reduce or eliminate the need for the vehicle computer 110 to translate of the virtual image plane 200 so as to make the virtual image projected into the virtual image plane 200 visible to the occupant eyebox 305. That is, moving the seat bottom along the x-axis and/or rotating the seatback about the y-axis, may account for at least a portion of the difference between the expected distance D and the predetermined distance P. As another example, the vehicle computer 110 may be programmed to actuate the HMI 118 to output an alert to the occupant to perform an adjustment to the seat 220 so as to make the virtual image visible within the occupant eyebox 305.

After performing the first adjustment and/or the second adjustment, the vehicle computer actuates the projector 155 to provide a virtual image to the SLM 150. Providing the virtual image to the SLM 150 allows the vehicle computer 110 to output an augmented reality image onto the windshield 210. Specifically, the vehicle computer 110 actuates the SLM 150 based on the updated pixel-wise phase matrix to output the virtual image into the virtual image plane 200 (e.g., after the first adjustment and/or the second adjustment). That is, the SLM 150 receives the virtual image as input and spatially modulates the virtual image according to the updated pixel-wise phase matrix to output the augmented reality image. The augmented reality image is provided in the virtual image plane 200 and is visible in the occupant eyebox 305 so as to be visible by the occupant. The vehicle computer 110 can determine respective occupant eyeboxes 305 for each detected occupant in the vehicle 105, and can, after performing respective first adjustments and/or second adjustments on respective virtual image planes, output respective augment reality images in the respective virtual image planes that are visible in the corresponding occupant eyebox 305 so as to be visible by the respective occupants.

FIG. 5 is a diagram of a deep neural network (DNN) 500 that can be trained to determine an expected distance D between an occupant eyebox 305 and a virtual image plane 200. The DNN 500 can be a software program that can be loaded in memory and executed by a processor included in a computer, for example. In an example implementation, the DNN 500 can include, but is not limited to, a convolutional neural network (CNN), R-CNN (Region-based CNN), Fast R-CNN, and Faster R-CNN. The DNN includes multiple nodes, and the nodes are arranged so that the DNN 500 includes an input layer, one or more hidden layers, and an output layer. Each layer of the DNN 500 can include a plurality of nodes 505. While FIG. 3 illustrate three (3) hidden layers, it is understood that the DNN 500 can include additional or fewer hidden layers. The input and output layers may also include more than one (1) node 505.

The nodes 505 are sometimes referred to as artificial neurons 505, because they are designed to emulate biological (e.g., human) neurons. A set of inputs (represented by the arrows) to each neuron 505 are each multiplied by respective weights. The weighted inputs can then be summed in an input function to provide, possibly adjusted by a bias, a net input. The net input can then be provided to an activation function, which in turn provides a connected neuron 505 an output. The activation function can be a variety of suitable functions, typically selected based on empirical analysis. As illustrated by the arrows in FIG. 5, neuron 505 outputs can then be provided for inclusion in a set of inputs to one or more neurons 505 in a next layer.

As one example, the DNN 500 can be trained with ground truth data (i.e., data about a real-world condition or state). For example, the DNN 500 can be trained with ground truth data and/or updated with additional data by a processor of the remote server computer 140. Weights can be initialized by using a Gaussian distribution, for example, and a bias for each node 505 can be set to zero. Training the DNN 500 can include updating weights and biases via suitable techniques such as back-propagation with optimizations. Ground truth data can include, but is not limited to data specifying objects (e.g., occupants, vehicles, etc.) within an image or data specifying a physical parameter. For example, the ground truth data may be data representing objects and object labels. In another example, the ground truth data may be data representing expected distances at which virtual images are visible in a virtual image plane 200 to various occupants given corresponding occupant vision acuity and weather conditions.

During operation, the vehicle computer 110 determines the occupant data and/or weather data (as discussed above) and provides the occupant data and/or weather data to the DNN 500. The DNN 500 generates a prediction based on the received input. The output is an expected distance D between the occupant eyebox 305 and the virtual image plane 200 given the occupant data and/or weather data.

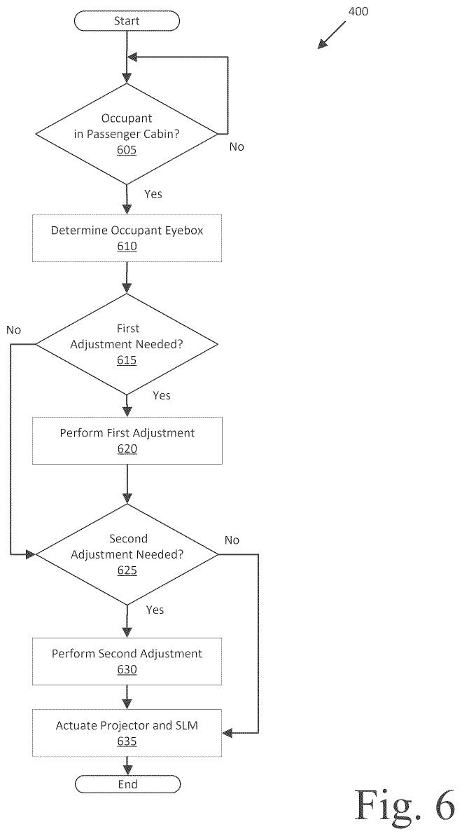

FIG. 6 is a diagram of an example process 600 for operating a vehicle 105. The process 600 begins in a block 605. The process 600 can be carried out by a vehicle computer 110 included in the vehicle 105 executing program instructions stored in a memory thereof.

In the block 605, the vehicle computer 110 determines whether an occupant is present in a passenger cabin 215 of the vehicle 105. The vehicle computer 110 can detect the presence of the occupant based on sensor 115 data, as discussed above. If the vehicle computer 110 detects the presence of the occupant, then the process 600 continues in a block 610. Otherwise, the process 600 remains in the block 605.

In the block 610, the vehicle computer 110 determines the occupant eyebox 305 for the occupant based on an actual pose for the occupant, as discussed above. Additionally, the vehicle computer 110 can determine an occupant virtual image plane 300 based on the occupant eyebox 305, as discussed above. The process 600 continues in the block 615.

In the block 615, the vehicle computer 110 determines whether a first adjustment of a virtual image plane 200 is needed based on the occupant eyebox 305. Prior to performing the first adjustment, the virtual image plane 200 corresponds to a reference eyebox 205, as discussed above. The vehicle computer 110 can compare the occupant virtual image plane 300 to the virtual image plane 200, as discussed above. If the virtual image plane 200 does not match the occupant image plane 300, as discussed above, then the vehicle computer 110 determines that the first adjustment is needed. If the vehicle computer 110 determines that the first adjustment is needed, then the process 600 continues in a block 620. Otherwise, the process 600 continues in a block 625.

In the block 620, the vehicle computer 110 performs the first adjustment. For example, the vehicle computer 110 can translate the virtual image plane 200 along at least one of a y-axis and a z-axis of a vehicle coordinate system to match the occupant virtual image plane 300, as discussed above. As another example, the vehicle computer 110 can translate a virtual image projected into the virtual image plane 200 relative to the virtual image plane 200 so as to be visible within the occupant eyebox 305, as discussed above. Additionally, or alternatively, the vehicle computer 110 can perform an adjustment of a seat 220 occupied by the occupant so as to make a virtual image projected into the virtual image plane 200 visible within the occupant eyebox 305, as discussed above. The process 600 continues in a block 625.

In the block 625, the vehicle computer 110 determines whether a second adjustment of the virtual image plane 200 is needed based on at least one of occupant data and weather data. The vehicle computer 110 determines an expected distance D between the occupant eyebox 305 and the virtual image plane 200 based on occupant data and/or weather data, as discussed above. If the expected distance D does not equal a predetermined distance P, as discussed above, then the vehicle computer 110 determines to perform the second adjustment. If the vehicle computer 110 determines to perform the second adjustment, then the process 600 continues in a block 630. Otherwise, the process 600 continues in a block 635.

In the block 630, the vehicle computer 110 performs the second adjustment. For example, the vehicle computer 110 can translate the virtual image plane 200 along an x-axis of the vehicle coordinate system based on the difference between the expected distance D and the predetermined distance P, as discussed above. Additionally, or alternatively, the vehicle computer 110 can perform the adjustment of the seat 220 occupied by the occupant so the virtual image projected into the virtual image plane 200 is visible in the occupant eyebox 305, as discussed above. The process 600 continues in a block 635.

In the block 635, the vehicle computer 110 actuates a projector 155 and an SLM 150 to output a virtual image into the virtual image plane 200, as discussed above. The process 600 ends following the block 635.

Systems and methods described herein may be modified and/or omitted depending on the context, situation, and applicable rules and regulations. Further, regardless actions that may be taken by a vehicle such as a computer controlling vehicle speed and/or acceleration, users should use good judgement and common sense when operating the vehicle. Operations described herein should always be implemented and/or performed in accordance with the owner manual and safety guidelines.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board first computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions (e.g., from a memory, a computer readable medium, etc.) and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system, comprising a computer including a processor and a memory, the memory storing instructions executable by the processor to:
determine a virtual image plane with respect to a reference eyebox, wherein a virtual image projected into the virtual image plane is visible in the reference eyebox;
determine, from sensor data, an occupant eyebox; and
perform a first adjustment of the virtual image plane based on the occupant eyebox so that the virtual image projected into the virtual image plane is visible in the occupant eyebox.

2. The system of claim 1, wherein the first adjustment includes translating the virtual image plane along at least one of a lateral axis partially defining the virtual image plane, and a vertical axis partially defining the virtual image plane and extending normal to the lateral axis.

3. The system of claim 1, wherein the first adjustment includes translating the virtual image within the virtual image plane.

4. The system of claim 1, wherein the instructions further include instructions to perform an adjustment to a position of a seat occupied by an occupant so that the virtual image is visible in the occupant eyebox.

5. The system of claim 1, wherein the instructions further include instructions to perform a second adjustment of the virtual image plane based on occupant data for an occupant.

6. The system of claim 5, wherein the second adjustment includes translating the virtual image plane along a longitudinal axis extending normal to the virtual image plane.

7. The system of claim 5, wherein the instructions further include instructions to input the occupant data for the occupant into a machine learning program that outputs an expected distance from the occupant eyebox to the virtual image plane.

8. The system of claim 7, wherein the second adjustment includes translating the virtual image plane along a longitudinal axis extending normal to the virtual image plane so that the virtual image plane is spaced from the occupant eyebox along the longitudinal axis by the expected distance.

9. The system of claim 5, wherein the instructions further include instructions to perform the second adjustment based on weather data in addition to the occupant data.

10. The system of claim 5, wherein the instructions further include instructions to perform an adjustment to a position of a seat occupied by the occupant so that the virtual image projected into the virtual image plane is visible in the occupant eyebox.

11. A method, comprising:
determining a virtual image plane with respect to a reference eyebox, wherein a virtual image projected into the virtual image plane is visible in the reference eyebox;
determining, from sensor data, an occupant eyebox; and
performing a first adjustment of the virtual image plane based on the occupant eyebox so that the virtual image projected into the virtual image plane is visible in the occupant eyebox.

12. The method of claim 11, wherein the first adjustment includes translating the virtual image plane along at least one of a lateral axis partially defining the virtual image plane, and a vertical axis partially defining the virtual image plane and extending normal to the lateral axis.

13. The method of claim 11, wherein the first adjustment includes translating the virtual image within the virtual image plane.

14. The method of claim 11, further comprising performing an adjustment to a position of a seat occupied by an occupant so that the virtual image is visible in the occupant eyebox.

15. The method of claim 11, further comprising performing a second adjustment of the virtual image plane based on occupant data for an occupant.

16. The method of claim 15, wherein the second adjustment includes translating the virtual image plane along a longitudinal axis extending normal to the virtual image plane.

17. The method of claim 15, further comprising inputting the occupant data for the occupant into a machine learning program that outputs an expected distance from the occupant eyebox to the virtual image plane.

18. The method of claim 17, wherein the second adjustment includes translating the virtual image plane along a longitudinal axis extending normal to the virtual image plane so that the virtual image plane is spaced from the occupant eyebox along the longitudinal axis by the expected distance.

19. The method of claim 15, further comprising performing the second adjustment based on weather data in addition to the occupant data.

20. The method of claim 15, further comprising performing an adjustment to a position of a seat occupied by the occupant so that the virtual image projected into the virtual image plane is visible in the occupant eyebox.
